(19) United States
(12) Patent Application Publication
(10) Pub. No.: US 2011/0273649 A1
(43) Pub. Date: Nov. 10, 2011

(54) LIQUID CRYSTAL DISPLAY DEVICE

(75) Inventors: Chikae MATSUI, Mobara (JP); Noboru Kunimatsu, Chiba (JP); Hidehiro Sonoda, Mobara (JP); Yuko Matsumoto, Onjuku (JP); Yosuke Hyodo, Mobara (JP)

(73) Assignees: Panasonic Liquid Crystal Display Co., Ltd.; Hitachi Displays, Ltd.

(21) Appl. No.: 13/104,142

(22) Filed: May 10, 2011

(30) Foreign Application Priority Data
May 10, 2010 (JP) 2010-108342

(51) Int. Cl. G02F 1/1335

(52) U.S. Cl. 349/107

(57) ABSTRACT

Each pixel formed on a TFT substrate includes a pixel electrode, and a TFT, a color filter, an opposed electrode and an insulating film are interposed between the pixel electrode and the TFT substrate. A liquid crystal layer is interposed between the TFT substrate and an opposed substrate. An alignment film is provided on each surface of the TFT substrate and the opposed substrate, the each surface being in contact with the liquid crystal layer. A material with high photoconductivity is used for forming the alignment film so as to suppress DC afterimage. Meanwhile, each thickness of the color filter for the respective colors is changed for preventing a yellow shift resulting from absorption of high intensity of light with short wavelength by the alignment film.

### CLAIM OF PRIORITY

The present application claims priority from Japanese Patent Application JP 2010-108342 filed on May 10, 2010, the content of which is hereby incorporated by reference into this application.

### BACKGROUND

1. Technical Field

The present invention relates to a display device, and more particularly, to a liquid crystal display device intended to cope with an afterimage phenomenon resulting from provision of a color filter on a substrate having a pixel electrode formed thereon.

2. Description of the Related Art

Generally, the liquid crystal display device which is thin and lightweight has been widely used in various fields from large-sized display device such as TV to mobile phones and Digital Still Camera (DSC). Meanwhile, the liquid crystal display device has a problem in view angle property of a phenomenon that the image as an anterior view has its brightness and chromaticity different from those of the image when viewed from oblique direction. The In Plane Switching (IPS) type configured to operate liquid crystal molecules by horizontal electric field has an excellent view angle property. There has been introduced a rubbing method which allows an alignment film for the liquid crystal display device to be subjected to the alignment process, that is, to function as the alignment control. The alignment process through rubbing is performed by rubbing the alignment film with cloth. Meanwhile, there has also been introduced a photo-alignment method for giving the alignment film the alignment control function in non-contact manner. The IPS type requires no pre-tilt angle, which allows application of the photo-alignment method.

In view of giving the alignment film the alignment control function, it is known that the photo-alignment method generally has lower alignment stability compared with the rubbing process. Low alignment stability may fluctuate the initial alignment direction, thus causing display defect.

Application of such material as polyamide acid alkyl ester is effective for obtaining alignment stability and long-term reliability of the photo-alignment film. Generally, this material has higher specific resistance than that of polyamide acid material. In the case where the dc voltage is superimposed with the signal waveform for driving the liquid crystal molecules to generate residual DC, the time constant taken until alleviation of the residual DC is large, which is likely to cause burning (DC afterimage).

Japanese Unexamined Patent Publication No. 2008-235900 discloses use of the alignment film formed of two layers. The alignment film as the upper layer in contact with the liquid crystal is formed of the material with high molecular weight and high alignment stability through photo-alignment using polyamide acid alkyl ester as the precursor. The alignment film as the lower layer is formed of the material with low molecular weight and low resistivity using polyamide acid as the precursor. The above-described related art discloses that use of the material with photoconductivity is effective for forming the alignment film as the lower layer.

The generally employed liquid crystal display device includes a TFT substrate having pixel electrodes and thin film transistors (TFT) arranged in matrix, and an opposed substrate having color filters at the positions corresponding to the pixel electrodes on the TFT substrate. Liquid crystal is interposed between the TFT substrate and the opposed substrate. The image is formed by controlling light transmittance by the liquid crystal molecules for each pixel.

The liquid crystal display device as related art requires the TFT substrate and the opposed substrate to be accurately aligned. The alignment process may increase manufacturing costs of the liquid crystal display device. However, it is impossible to align those TFT substrate and the opposed substrate completely with accuracy. For this, a margin is provided for such alignment as a whole, which needs to provide the area for black matrix with the size corresponding to the margin. Then transmittance to the liquid crystal display panel is reduced, resulting in loss of the display brightness.

Technology for forming the color filters on the TFT substrate has been developed. The color filters provided on the TFT substrate may be aligned with the pixel electrodes using photolithography process, resulting in higher positioning accuracy compared with the alignment of the TFT substrate and the opposed substrate. The process for forming the color filter on the opposed substrate needs the step similar to the process for forming the color filter on the TFT substrate. As a result, the process for forming the color filter does not have to be added to the process steps.

The method of providing the color filters on the TFT substrate (Color Filter on Array, hereinafter referred to as COA) makes it possible to reduce manufacturing costs and to enhance brightness of the display by transmittance of the liquid crystal display device.

Meanwhile, DC afterimage occurs in the liquid crystal display device. More specifically, when a given image is displayed for a predetermined time period, electric charges are accumulated in the alignment film, which apparently looks like burned on the screen for a certain period of time. Duration of the DC afterimage may be measured by decreasing the alignment film.

The liquid crystal display device employs a back light. Use of the material with photoconductivity for forming the alignment film may reduce its electric resistance in operation. In this way, the alignment film with photoconductivity has been employed for a large number of liquid crystal display devices.

With COA, the color filters are formed closer to the back light than the alignment film, and accordingly, the intensity of light from the back light which reaches the alignment film is lower compared with the related art, thus failing to supply sufficient photoconductivity to the alignment film. The resistance of the alignment film in operation cannot be reduced. So the DC afterimage is serious problem for the COA. It is therefore an object of the present invention to cope with the DC afterimage which occurs in the COA.

### SUMMARY OF THE INVENTION

The present invention solves the above problems with specific measures as follows. That is, the present invention provides a liquid crystal display device including a TFT substrate which has red pixels each provided with a red color filter, a TFT, an opposed electrode and a pixel electrode, green pixels each provided with a green color filter, a TFT, an opposed electrode and a pixel electrode, and blue pixels each provided with a blue color filter, a TFT, an opposed electrode and a pixel electrode, which are arranged in matrix, and an opposed substrate. A liquid crystal is interposed between the TFT substrate and the opposed substrate. An alignment film is provided on each surface of the TFT substrate and the opposed substrate, the each surface being in contact with the liquid crystal, and the alignment film exhibiting photoconductivity. Each thickness of the color filters provided on the TFT substrate establishes a relationship: a thickness of the red color filter>a thickness of the green color filter>a thickness of the blue color filter.

Another aspect of the present invention provides a liquid crystal display device including a TFT substrate which has red pixels each provided with a red color filter, a TFT, an opposed electrode and a pixel electrode, green pixels each provided with a green color filter, a TFT, an opposed electrode and a pixel electrode, and blue pixels each provided with a blue color filter, a TFT, an opposed electrode and a pixel electrode, which are arranged in matrix, and an opposed substrate. A liquid crystal is interposed between the TFT substrate and the opposed substrate. An alignment film is provided on each surface of the TFT substrate and the opposed substrate, the each surface being in contact with the liquid crystal, and the alignment film exhibiting photoconductivity. The following relationship is established: an area of the blue color filter that occupies a portion of the blue pixel through which a light transmits for forming an image>an area of the green color filter that occupies a portion of the green pixel through which a light transmits for forming an image>an area of the red color filter that occupies a portion of the red pixel through which a light transmits for forming an image.

The present invention provides the IPS liquid crystal display device of COA type, which is capable of suppressing the DC afterimage and preventing yellow shift on the display.

### BRIEF DESCRIPTION OF THE DRAWINGS

FIG. 1 is a sectional view of a liquid crystal display panel according to a first embodiment;

FIG. 2 is a plan view of a pixel electrode of IPS;

FIG. 3 is a graph representing transmittance values of the alignment film used in the present invention for each wavelength;

FIG. 4 is a graph representing transmittance values of the alignment film for each color in accordance with the present invention;

FIG. 5 is a view representing a pattern used for evaluating the DC afterimage;

FIG. 6 is a graph representing an evaluation result with respect to the DC afterimage; and

FIG. 7 is a sectional view of a liquid crystal display panel according to the second embodiment.

### DESCRIPTION OF THE PREFERRED EMBODIMENT

The present invention will be described in detail in reference to Embodiments.

### First Embodiment

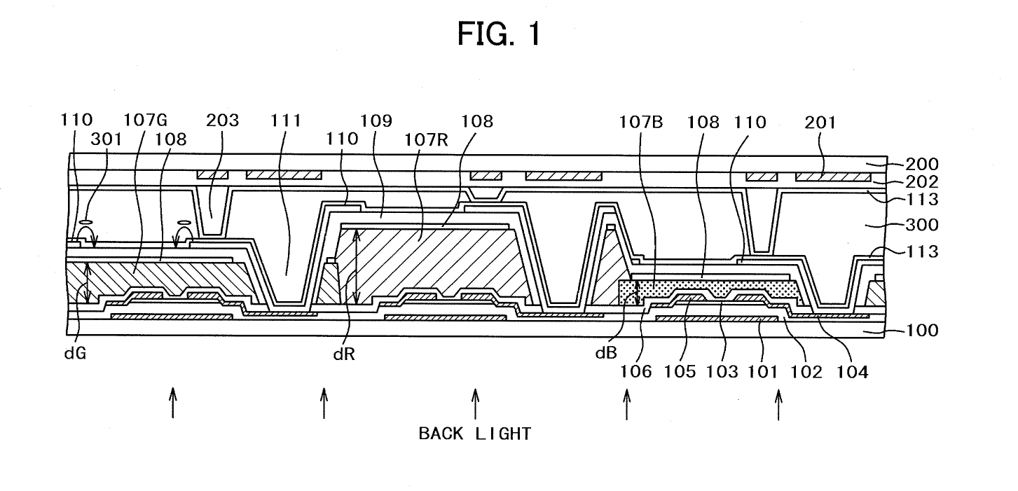

FIG. 1 is a sectional view of a liquid crystal display panel according to a first embodiment of the present invention. FIG. 1 illustrates the IPS of the COA type in which pixels provided with TFTs, opposed electrodes 108, pixel electrodes 110, and color filters 107R, 107G and 107B are formed on a TFT substrate 100 in matrix.

As FIG. 1 shows, alignment films 113 are formed on surfaces of the TFT substrate 100 and an opposed substrate 200 which face a liquid crystal layer 300. The material with higher photoconductivity than for the generally employed liquid crystal display panel is used for forming each of the respective alignment films 113 formed at both sides of the TFT substrate 100 and the opposed substrate 200, respectively for coping with the DC afterimage characteristic. In other words, the material having the electric resistance largely reduced by low light intensity is used for forming the alignment film. As the material with photoconductivity for forming the alignment film, the product SE6410 manufactured by NISSAN CHEMICAL INDUSTRIES, LTD. may be employed. Such material may have its photoconductivity variable by changing the ratio of components.

As for the IPS, the electric resistance of the alignment film 113 at the side of the TFT substrate 100 where the pixel electrode 110 is provided mainly influences the DC afterimage. The alignment film 113 with higher photoconductivity may be provided at the side of the TFT substrate 100. In the present embodiment, the same material for forming the alignment film is employed at both sides of the TFT substrate 100 and the opposed substrate 200 in order to standardize the material for forming the alignment film.

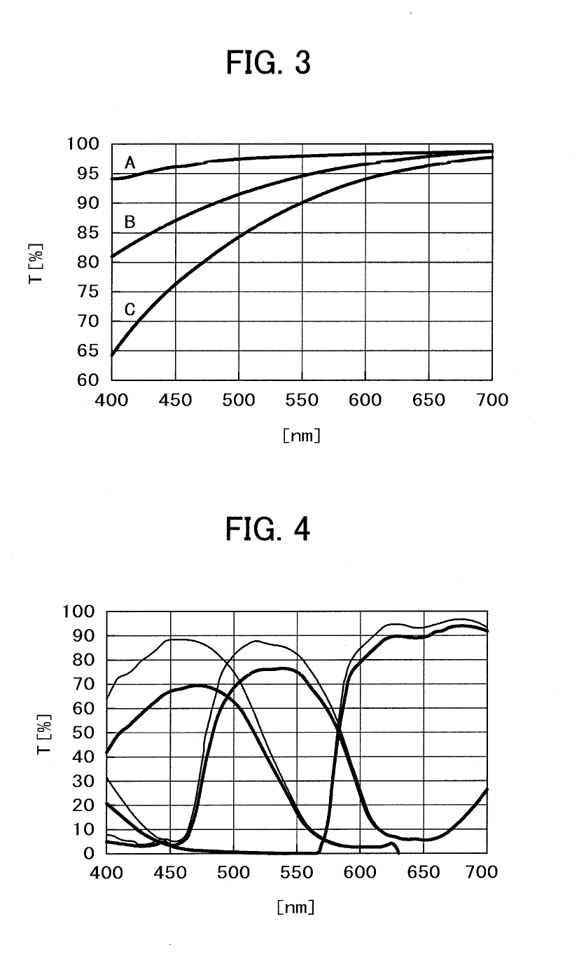

The alignment film 113 with photoconductivity exhibits absorbance which varies with wavelength. FIG. 3 represents the transmittance property of the alignment film 113 for each wavelength as opposed to the light absorbance property of the alignment film 113. Referring to FIG. 3, x-axis denotes wavelength of light, and y-axis denotes light transmittance of the alignment film. The curve A represents dependency of the transmittance of single layer alignment film of the generally employed liquid crystal display device on the wavelength. Curve B represents dependency of the transmittance of single layer alignment film according to the present embodiment on the wavelength. Curve C represents dependency of the transmittance of two layers of the alignment film according to the present embodiment, that is, provided at both sides of the TFT substrate and the opposed substrate on the wavelength.

As FIG. 3 indicates, the alignment film will absorb more light with shorter wavelength because of its contribution to the photoconductivity. The transmittance property of the alignment film according to the present embodiment shows lower values than those of the generally employed alignment film especially in terms of short wavelength. For example, transmittance of light with wavelength of 400 nm of the generally employed alignment film as the single layer shows 94%. Meanwhile, the transmittance of the alignment film to be used according to the present invention shows 81% as the single layer and 65% as double layers. It is possible to use the alignment film as the single layer with its transmittance of light with wavelength of 400 nm ranging from 50% to 90%.

A fluorescent tube or LED may be used as the back light of the liquid crystal display device. The light from the back light contains three wavelengths of R, G, and B. Referring to FIG. 3, at the short wavelength side, when the transmittance is lowered, intensity of the light at the long wavelength side transmitting through the alignment film or the liquid crystal display panel is increased, which makes the displayed image to appear reddish. This phenomenon is called yellow shift.

FIG. 4 is a graph representing each transmittance of the alignment film for each color with respect to the light with three wavelengths from the back light.

Referring to FIG. 4, x-axis denotes wavelength of light, and y-axis denotes transmittance. In FIG. 4, the thin line represents the transmittance of the alignment film of the generally employed liquid crystal display device for the respective colors. The bold line represents the transmittance of the alignment film of the structure according to the present embodiment for the respective colors.

As represented by FIG. 4, the alignment film of the generally employed liquid crystal display panel shows lower light absorbance. There is substantially no difference in the transmittance values among those colors of blue, green and red, and accordingly, coloring problem hardly occurs. The alignment film with high photoconductivity used in the present invention exhibits high light absorbance especially at the short wavelength side. The transmittance becomes especially low with respect to blue, and it becomes higher with respect to green, and then red sequentially. This phenomenon indicates transition of the display color to the red side, specifically, yellow shift occurs on the display. This may prevent accurate reproduction of the image.

The above-described color shifting problem is solved in the first embodiment by changing thickness of the color filter for each pixel as shown in FIG. 1. Specifically, the thickness of the red color filter 107R is made the largest, the thickness of the green color filter 107G is made the second largest, and the thickness of the blue color filter 107B is made the smallest. As the thickness of the color filter becomes larger, the amount of light transmitting through the color filter becomes small. This makes it possible to compensate dependency of the absorbance of the alignment film on the wavelength.

Arrows shown in FIG. 1 indicate light rays emitted from the back light.

Specifically, supposing that the thickness of the green color filter 107G is set to 1, the thickness of the red color filter 107R is set to be in the range from 1.5 to 4, and the thickness of the blue color filter 107B is set to be in the range from 0.2 to 0.67. Referring to FIG. 1, the color filter is formed above the TFT. Actually, in most part of the region where the color filters are formed, the TFTs do not exist. Therefore, the color filter is not necessarily required to be provided above the TFT. Each thickness of the respective color filters may be set to the thickness value of the portion where no TFT is formed as illustrated in FIG. 1.

Use of the alignment film with high photoconductivity, that is, very small transmittance on the short wavelength side may prevent yellow shifting on the display. The effect of the DC afterimage characteristic to be improved by the use of the structure according to the present embodiment will be described below.

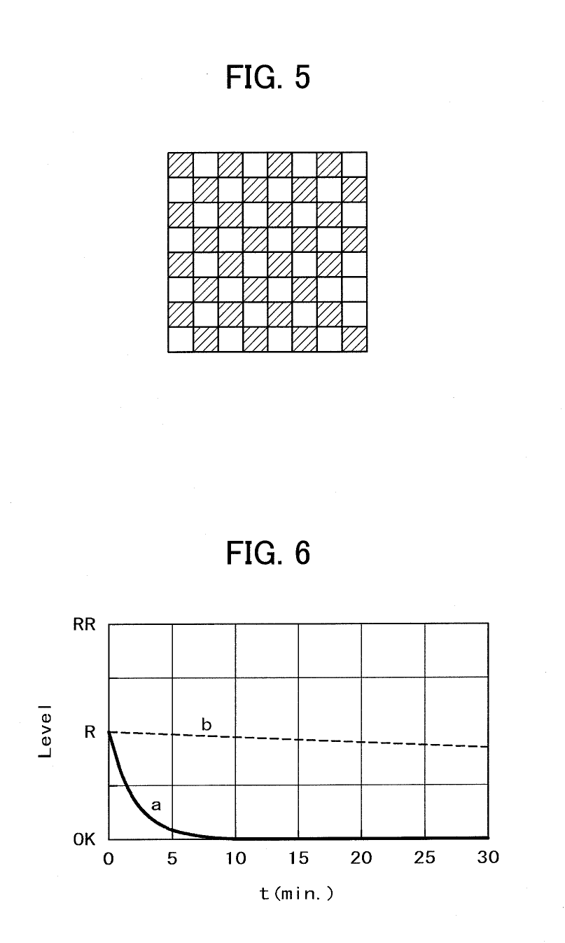

The DC afterimage is evaluated by displaying 8×8 black and white checker flag pattern as shown in FIG. 5 for 12 hours, and then returning the display to the one with solid gray halftone with gradation of 64/256. Upon elapse of 10 minutes from return to the halftone display, if the checker flag pattern can be identified, it is determined as NG. If the checker flag pattern cannot be identified, it is determined as OK.

FIG. 6 represents evaluation results of the DC afterimage, having x-axis that denotes the time elapsing from return to the solid gray halftone display, and y-axis that denotes level of the DC afterimage. Referring to the y-axis, RR denotes the state where the checker flag pattern is well identified upon return to the halftone display, thus indicating NG. R denotes the state where the checker flag pattern is vaguely identified upon return to the halftone display.

Referring to FIG. 6, the curve “a” represents the DC afterimage characteristic when using the alignment film with high photoconductivity in the structure according to the present embodiment, that is, the COA. The curve “b” represents the DC afterimage characteristic when using the alignment film with photoconductivity in the ODA at level corresponding to the one for the related art.

In the case where the afterimage upon return to the halftone display is at the level R, this is not practically a problem as long as such phenomenon disappears within a short period of time. In the case where the generally employed alignment film is used for the COA, the afterimage at the level close to the level R is kept for a long time after return to the halftone display, thus causing a problem in practice. In the case of the structure according to the present invention, the DC afterimage is sharply decreased, and completely erased for approximately 7 minutes after return to the halftone display. According to the present embodiment, use of the alignment film with high photoconductivity erases the DC afterimage, and at the same time, suppresses the yellow shift by changing each thickness of the color filters for the respective colors.

The structure shown in FIG. 1 will be described hereinafter. Various kinds of electrode structures of the liquid crystal display device of IPS type have been proposed and further put into practical use. FIG. 1 illustrates the structure which has been used in a wide range of field. To put it simply, a comb-like pixel electrode 110 is formed on the opposed electrode 108 with a solid plane surface, having the insulation film interposed therebetween. The voltage between the pixel electrode 110 and the opposed electrode 108 serves to rotate liquid crystal molecules 301 to control transmittance of light through the liquid crystal layer 300 for each pixel, thus forming the image. The structure shown in FIG. 1 will be described in detail. The present invention will be described in the form of the structure as shown in FIG. 1. However, the present invention is applicable to the liquid crystal display device of IPS type other than the one shown in FIG. 1.

Referring to FIG. 1, a gate electrode 101 is formed on the TFT substrate 100 formed of glass. The gate electrode 101 is formed as the same layer as scan lines, having MoCr alloy laminated on AlNd alloy, for example.

A gate insulating film 102 formed of SiN coats the gate electrode 101. A semiconductor layer 103 formed of an a-Si film is provided at the position opposite the gate electrode 101 on the gate insulating film 102. The a-Si film is formed using plasma CVD for forming channel portion of the TFT. A source electrode 104 and a drain electrode 105 are formed on the a-Si film while interposing the channel portion. An n+Si layer, not shown, is formed between the a-Si film and the source electrode 104 or the drain electrode 105 for making ohmic contact between the semiconductor layer and the source electrode 104 or the drain electrode 105. The TFT which has been described so far is of bottom gate type. However, the present invention is applicable to the TFT of top gate type.

An inorganic passivation film 106 formed of SiN coats the TFT so that a part of the TFT, especially its channel portion is protected from impurities. An organic passivation film is formed on the inorganic passivation film 106 in the generally employed structure. In the COA, however, color filters are formed instead of the organic passivation film. As FIG. 1 shows, the thickness of the color filter is different depending on the color. For example, the green color filter 107G has its thickness ranging from 1 to 1.5 μm. As described above, supposing that the thickness of the green color filter 107G is set to 1, the thickness of the red color filter 107R ranges from 1.5 to 4, and the thickness of the blue color filter 107B ranges from 0.2 to 0.67, respectively.

The color filter has through holes for connecting the pixel electrodes 110 and the source electrodes 104. The opposed electrodes 108 are provided on the color filters 107R, 107G and 107B, respectively. The opposed electrode 108 is formed by sputtering Indium Tin Oxide (ITO) as transparent conductive film over an entire display region. In other words, the opposed electrode 108 is formed to be planar. After forming the opposed electrode 108 by sputtering over the entire surface, the opposed electrode 108 corresponding to the through holes for conduction between the pixel electrode 110 and the source electrode 104 is removed by etching.

An upper insulating film 109 formed of SiN coats the opposed electrode 108. After forming the upper insulating film 109, through holes 111 are formed by etching. The inorganic passivation film 106 is etched while using the upper insulating film 109 as resist to form the through hole 111. Thereafter, the ITO is formed into the pixel electrode 110 while coating the upper insulating film 109 and the through hole 111 by sputtering. The sputtered ITO is patterned to form the comb-like pixel electrode 110. The ITO formed as the pixel electrode 110 is deposited in the through hole 111. The source electrode 104 and the pixel electrode 110 extending from the TFT are conducted in the through hole 111 so that the video signal is supplied to the pixel electrode 110.

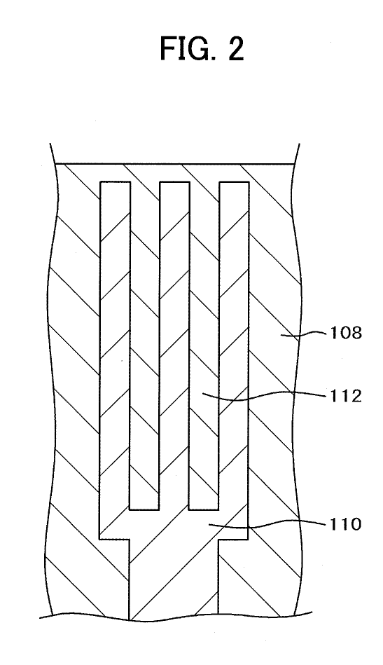

FIG. 2 illustrates an example of the pixel electrode 110 with a comb-like shape having one closed end. A slit 112 is formed between tyne-like portions. The planar opposed electrode 108 is formed below the pixel electrode 110. When a video signal is applied to the pixel electrode 110, the liquid crystal molecule 301 is rotated by an electric line of force generated between the opposed electrode 108 and the pixel electrode 110 via the slit 112. Light transmitting through the liquid crystal layer 300 is controlled to form the image.

FIG. 1 is a sectional view illustrating the aforementioned state. Fixed voltage is applied to the opposed electrode 108, and the voltage corresponding to the video signal is applied to the pixel electrode 110. Upon application of the voltage to the pixel electrode 110, the electric line of force generated as illustrated in FIG. 1 rotates the liquid crystal molecule 301 in the direction of the electric line of force to control transmission of the light from the back light. In this way, the image is formed by controlling the transmitting light from the back light for each pixel.

Referring to the example shown in FIG. 1, the planar opposed electrodes 108 are provided on the color filters 107R, 107G, and 107B, respectively. The comb-like electrode 110 is provided on the upper insulating film 109. On the other hand, the pixel electrodes 110 as planar configurations are provided on the color filters 107R, 107G and 107B, and the comb-like opposed electrode 108 may be provided on the upper insulating film 109.

The alignment film 113 for aligning the liquid crystal molecule 301 is provided on the pixel electrode 110. According to the present invention, the alignment film 113 is formed of the one with higher photoconductivity than that of the alignment film used for the generally employed structure. In other words, the alignment film 113 capable of providing the photoconductivity effect irrespective of intensity reduced through the color filter is used. This makes it possible to suppress the DC afterimage.

Referring to FIG. 1, an opposite substrate 200 is provided to interpose the liquid crystal layer 300. A black matrix 201 is formed inside the opposed substrate 2 00. The black matrix 201 covers the portion which does not contribute to image formation so as to improve contrast. An overcoat film 202 is provided to cover the black matrix 201 for the surface planarization.

A column spacer 203 is provided on the overcoat film 202. The column spacer 203 is formed by applying the resin such as acryl to the opposed substrate 200 with a predetermined thickness, and etching the resin through photolithography process to remove undesired portion. Each of the column spacers 203 has a different height depending on each pixel color. The column spacer for the blue pixel is the highest, and the column spacer for the red pixel is the shortest.

A difference in height of the column spacer 203 may be realized using halftone exposure technique during exposure of the resin. Among the column spacers 203, the one for the red pixel is the shortest, for example, approximately 1 μm. In this case, the thickness of the liquid crystal layer 300 becomes 1 μm as well. However, the IPS is sufficiently operated so long as the layer thickness of the liquid crystal is approximately 0.5 μm. Accordingly, the resultant structure may be operated as the liquid crystal display panel with no problem.

The alignment film 113 is provided while coating the overcoat film 202 and the column spacer 203. In the present embodiment, the material with high photoconductivity is used for forming the alignment film 113 at the side of the opposed substrate 200. This is because use of the same material for forming the alignment film at the TFT substrate 100 is advantageous for simplifying the process. However, in the case of the IPS, the specific resistance of the alignment film 113 on the side of the TFT substrate 100 mainly influences the DC afterimage. So the material with high photoconductivity may only be used for forming the alignment film 113 on the side of the TFT substrate 100, and the general alignment film may be used as the alignment film 113 on the side of the opposed substrate 200.

According to the present embodiment, the IPS of COA type allows suppression of the DC afterimage without causing color shift.

### Second Embodiment

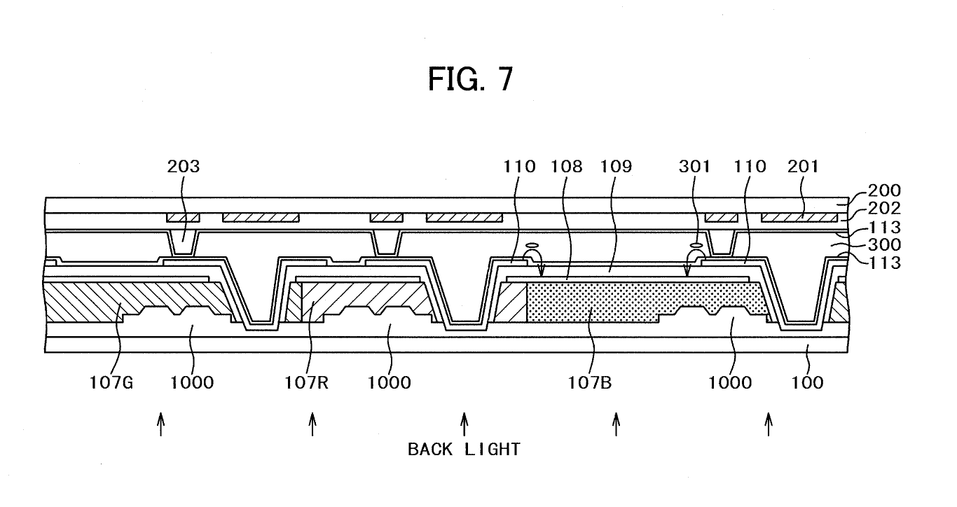

FIG. 7 is a sectional view of a liquid crystal display panel according to the second embodiment of the present invention. The present embodiment provides COA intended to prevent color shift on the display while suppressing the DC afterimage. Referring to FIG. 7, the color filters 107R, 107G, and 107B are provided on the TFT substrate 100 to form the COA structure. Arrows shown in FIG. 7 denote light rays from the back light.

In FIG. 7, the material with high photoconductivity is used for forming the alignment film 113. Its photoconductivity is higher than that of the alignment film used for the liquid crystal panel as the generally employed structure. This makes it possible to reduce electric resistance of the alignment film 113 in operation, thus suppressing the DC afterimage.

The alignment film 113 shown in FIG. 7 has its transmittance reduced at the short wavelength side likewise the case described referring to FIGS. 3 and 4. If intensity of the light input to each pixel is the same, the yellow shift occurs on the display. In the present embodiment, the pixels have different areas so as to compensate the color shift caused by the alignment film 113.

Referring to FIG. 7, the area of the blue pixel is the largest, the area of the green pixel is the second largest, and the area of the red pixel is the smallest. As FIG. 4 illustrates, the alignment film used in the present embodiment provides the largest absorbance in the blue spectrum, and the smallest absorbance in the red spectrum. If no particular countermeasure is taken, color shift to red occurs on the display. In other words, the yellow shift occurs on the display, which may interfere with correct color reproduction.

In order to compensate the aforementioned error, areas of the respective pixels are changed. Specifically, assuming that the area of the green color filter 107G is set to 1, the area of the red color filter 107R is in the range from 0.2 to 0.67, and the area of the blue color filter 107B is in the range from 1.5 to 4. BY changing the areas of the respective color filters in the above-described ranges may prevent the yellow shift on the display.

On the TFT substrate, scan lines extend in the first direction and are arranged in a second reaction, and video signal lines extend in the second direction and are arranged in the first direction. The regions defined by the scan lines and the video signal lines are formed as pixels. Each pixel has a portion which does not contribute to light transmission for forming the image, for example, TFT. Each area of the respective color filters 107R, 107G, and 107B corresponds to the color filter area at the portion through which the light transmits for actually forming the image.

In the present embodiment, the first layer of the alignment film has the transmittance ranging from 50% to 90%. The effect for the DC afterimage according to the present embodiment is the same as that derived from the first embodiment as described referring to FIGS. 5 and 6.

Referring to FIG. 7, each thickness of the color filters 107R, 107G and 107B corresponding to the respective pixels is the same, and each height of the column spacers 203 provided on the opposed substrate is the same. In the present embodiment, halftone exposure technology does not have to be used for forming the column spacer 203. In this case, the height of the column spacer 203 is in the range from 3 to 4 μm for the respective pixels. TFTs 1000 formed below the respective color filters have the same structures as shown in FIG. 1. The detailed structure of the TFT 1000 is not shown in FIG. 7. Other structures shown in FIG. 7 are the same as those described referring to FIG. 1, and explanations thereof, thus, will be omitted.

The present embodiment is made by using the alignment film 113 with high photoconductivity, and changing each area of the color filters 107R, 107G and 107B so as to be different from one another. This makes it possible to suppress the DC afterimage, and to further prevent the yellow shift on the display owing to dependency of the transmittance of the alignment film 113 on the wavelength.

What is claimed is:

1. A liquid crystal display device including a TFT substrate which has red pixels each provided with a red color filter, a TFT, an opposed electrode and a pixel electrode, green pixels each provided with a green color filter, a TFT, an opposed electrode and a pixel electrode, and blue pixels each provided with a blue color filter, a TFT, an opposed electrode and a pixel electrode, which are arranged in matrix, and an opposed substrate, a liquid crystal being interposed between the TFT substrate and the opposed substrate,
wherein an alignment film is provided on each surface of the TFT substrate and the opposed substrate, the each surface being in contact with the liquid crystal, and the alignment film exhibiting photoconductivity; and
each thickness of the color filters provided on the TFT substrate establishes a relationship: a thickness of the red color filter>a thickness of the green color filter>a thickness of the blue color filter.

2. The liquid crystal display device according to claim 1, wherein when the thickness of the green color filter is set to 1, the thickness of the red color filter is set to be in a range from 1.5 to 4, and the thickness of the blue color filter is set to be in a range from 0.2 to 0.67.

3. A liquid crystal display device including a TFT substrate which has red pixels each provided with a red color filter, a TFT, an opposed electrode and a pixel electrode, green pixels each provided with a green color filter, a TFT, an opposed electrode and a pixel electrode, and blue pixels each provided with a blue color filter, a TFT, an opposed electrode and a pixel electrode, which are arranged in matrix, and an opposed substrate, a liquid crystal being interposed between the TFT substrate and the opposed substrate,
wherein an alignment film is provided on each surface of the TFT substrate and the opposed substrate, the each surface being in contact with the liquid crystal, and the alignment film exhibiting photoconductivity; and
the following relationship is established: an area of the blue color filter that occupies a portion of the blue pixel through which a light transmits for forming an image>an area of the green color filter that occupies a portion of the green pixel through which a light transmits for forming an image>an area of the red color filter that occupies a portion of the red pixel through which a light transmits for forming an image.

4. The liquid crystal display device according to claim 3, wherein when the area of the green color filter that occupies the portion of the green pixel through which the light transmits for forming the image is set to 1, the area of the blue color filter that occupies the portion of the blue pixel through which the light transmits for forming the image is set to be in a range from 1.5 to 4, and the area of the red color filter that occupies the portion of the red pixel through which the light transmits for forming the image is set to be in a range from 0.2 to 0.67.

5. A liquid crystal display device including a TFT substrate which has red pixels each provided with a red color filter, a TFT, and a first electrode formed on the red color filter in a solid planar manner, and a comb-like second electrode formed on the first electrode having an insulating film interposed between the first and the second electrodes, green pixels each provided with a green color filter, a TFT, a first electrode formed on the green color filter in a solid planar manner, and a comb-like second electrode formed on the first electrode having an insulating film interposed between the first and the second electrodes, and blue pixels each provided with a blue color filter, a TFT, and a first electrode formed on the blue color filter in a solid planar manner, and a comb-like second electrode formed on the first electrode having an insulating film interposed between the first and the second electrodes, which are arranged in matrix, and an opposed substrate, a liquid crystal being interposed between the TFT substrate and the opposed substrate,
wherein an alignment film is provided on each surface of the TFT substrate and the opposed substrate, the each surface being in contact with the liquid crystal, and the alignment film exhibiting photoconductivity; and
each thickness of the color filters provided on the TFT substrate establishes a relationship: a thickness of the red color filter>a thickness of the green color filter>a thickness of the blue color filter.

6. A liquid crystal display device including a TFT substrate which has red pixels each provided with a red color filter, a TFT, and a first electrode formed on the red color filter in a solid planar manner, and a comb-like second electrode formed on the first electrode having an insulating film interposed between the first and the second electrodes, green pixels each provided with a green color filter, a TFT, a first electrode formed on the green color filter in a solid planar manner, and a comb-like second electrode formed on the first electrode having an insulating film interposed between the first and the second electrodes, and blue pixels each provided with a blue color filter, a TFT, and a first electrode formed on the blue color filter in a solid planar manner, and a comb-like second electrode formed on the first electrode having an insulating film interposed between the first and the second electrodes, which are arranged in matrix, and an opposed substrate, a liquid crystal being interposed between the TFT substrate and the opposed substrate
wherein an alignment film is provided on each surface of the TFT substrate and the opposed substrate, the each surface being in contact with the liquid crystal, and the alignment film exhibiting photoconductivity; and
the following relationship is established: an area of the blue color filter that occupies a portion of the blue pixel through which a light transmits for forming an image>an area of the green color filter that occupies a portion of the green pixel through which a light transmits for forming an image>an area of the red color filter that occupies a portion of the red pixel through which a light transmits for forming an image.
